(19) United States
(12) Patent Application Publication
(10) Pub. No.: US 2013/0236822 A1
(43) Pub. Date: Sep. 12, 2013

(54) IMAGE FORMING APPARATUS AND PROCESS CARTRIDGE

(71) Applicants: Keiko ONO, Kanagawa (JP); Kosuke NARITA, Kanagawa (JP); Hirofumi NAKAMURA, Kanagawa (JP)

(72) Inventors: Keiko ONO, Kanagawa (JP); Kosuke NARITA, Kanagawa (JP); Hirofumi NAKAMURA, Kanagawa (JP)

(73) Assignee: FUJI XEROX CO., LTD., Tokyo (JP)

(21) Appl. No.: 13/606,787

(22) Filed: Sep. 7, 2012

(30) Foreign Application Priority Data
Mar. 12, 2012 (JP) 2012-055073

(51) Int. Cl. G03G 15/00; G03G 21/18

(52) U.S. Cl. 430/56; 399/111; 399/159

(57) ABSTRACT

An image forming apparatus includes an electrophotographic photoreceptor, a charging unit charging the electrophotographic photoreceptor, an exposing unit exposing the charged electrophotographic photoreceptor to form an electrostatic latent image, a developing unit developing the electrostatic latent image to form a toner image, and a transferring unit transferring the toner image to a recording medium, but includes no erasing unit erasing the electrophotographic photoreceptor after the toner image is transferred and before the electrographic photoreceptor is charged. The electrophotographic photoreceptor has an undercoat layer and a photosensitive layer on a conductive substrate. The undercoat layer has metallic oxide particles and an electron-accepting compound. The electron-accepting compound is included at 1 part by weight to 5 parts by weight with respect to 100 parts by weight of the metallic oxide particles. A volume resistivity of the undercoat layer is in a range of 1.0×10⁹ Ωm to 1.0×10¹⁰ Ωm.

### CROSS-REFERENCE TO RELATED APPLICATIONS

This application is based on and claims priority under 35 USC 119 from Japanese Patent Application No. 2012-055073 filed Mar. 12, 2012.

### BACKGROUND

1. Technical Field

The invention relates to an image forming apparatus and a process cartridge.

2. Related Art

In recent years, forming images in an electrophotographic manner has been widely used in image forming apparatuses, such as copying machines and laser printers.

### SUMMARY

According to an aspect of the invention, there is provided an image forming apparatus including an electrophotographic photoreceptor, a charging unit that charges a surface of the electrophotographic photoreceptor through contact charging in which only direct voltage is applied, an exposing unit that exposes the charged surface of the electrophotographic photoreceptor so as to form an electrostatic latent image, a developing unit that develops the electrostatic latent image using a developer so as to form a toner image, and a transferring unit that transfers the toner image to a recording medium, and not having an erasing unit that erases the surface of the electrophotographic photoreceptor after the toner image is transferred to the recording medium using the transferring unit and before the surface of the electrographic photoreceptor is charged using the charging unit, in which the electrophotographic photoreceptor has an undercoat layer and a photosensitive layer on a conductive substrate, the undercoat layer has metallic oxide particles having been surface-treated with a coupling agent containing an amino group and an electron-accepting compound having an anthraquinone structure, the electron-accepting compound is included in a range of 1 part by weight to 5 parts by weight with respect to 100 parts by weight of the metallic oxide particles, and a volume resistivity of the undercoat layer is in a range of 1.0×10⁹ Ωm to 1.0×10¹⁰ Ωm in measurement through an alternating current impedance method.

### BRIEF DESCRIPTION OF THE DRAWINGS

Exemplary embodiments of the present invention will be described in detail based on the following figures, wherein:

FIG. 1 is a schematic view showing a cross-section of a part of an electrophotographic photoreceptor according to the exemplary embodiment;

FIG. 2 is a schematic view showing the basic configuration of an image forming apparatus of a first exemplary embodiment;

FIG. 3 is a schematic view showing the basic configuration of an image forming apparatus of a second exemplary embodiment; and

FIG. 4 is a schematic view showing the basic configuration of an example of a process cartridge.

### DETAILED DESCRIPTION

Hereinafter, exemplary embodiments will be described in detail. Meanwhile, in the drawings, there are cases in which the same or equivalent parts will be given the same reference symbols, and will not be described again.

Image Forming Apparatus

An image forming apparatus of the present exemplary embodiment has an electrophotographic photoreceptor, a charging unit that charges a surface of the electrophotographic photoreceptor, an electrostatic latent image forming unit that exposes a charged surface of the electrophotographic photoreceptor so as to form an electrostatic latent image, a developing unit that develops the electrostatic latent image using a developer so as to form a toner image, and a transferring unit that transfers the toner image to a recording medium.

In addition, a contact charging-type charging unit in which only a direct voltage is applied is employed as the charging unit.

Also, the electrophotographic photoreceptor has at least a conductive substrate, an undercoat layer, and a photosensitive layer, the undercoat layer has metallic oxide particles having been surface-treated with a coupling agent containing an amino group and an electron-accepting compound having an anthraquinone structure, and the electron-accepting compound is included in a range of 1 part by weight to 5 parts by weight with respect to 100 parts by weight of the metallic oxide particles. Furthermore, an electrophotographic photoreceptor in which a volume resistivity of the undercoat layer is in a range of 1.0×10⁹ Ωm to 1.0×10¹⁰ Ωm in measurement through an alternating current impedance method is employed.

Here, in the electrographic photoreceptor, it is considered that, when the metallic oxide particles having been surface-treated with a coupling agent containing an amino group are dispersed in the undercoat layer, the blocking capability at the interface between the undercoat layer and the photosensitive layer (for example, the charge generation layer) improves, the resistance-adjusting function is adjusted so as to suppress occurrence of fogging, and the electrical characteristics are stabilized so as to suppress density deterioration caused by repetitive use.

However, in an image forming apparatus in which charging is carried out using a contact charging method in which only a direct voltage is applied, but an erasing device is not used for erasing, ghost may occur depending on the surface treatment state of the metallic oxide particles dispersed in the undercoat layer of the electrophotographic photoreceptor.

Occurrence of ghost is considered to result from corrosion of the conductive substrate due to an oxidation and reduction reaction between the coupling agent having an amino group and the conductive substrate.

In addition, occurrence of ghost is considered to have a relationship with the film resistance of the undercoat layer and the surface treatment state of the metallic oxide particles, and is confirmed that occurrence of ghost worsens as the film resistance of the undercoat layer increases in order to obtain the high contrast of an image.

Therefore, in the image forming apparatus according to the exemplary embodiment, the volume resistivity (film resistance) of the undercoat layer is set to be as high as in a range of 1.0×10⁹ Ωm to 1.0×100 Ωm in order to disperse the metallic oxide particles having been surface-treated with the coupling agent having an amino group in the undercoat layer of the electrophotographic photoreceptor, and obtain an increase in the contrast of an image, which are intended to suppress occurrence of fogging and stabilize the electrical characteristics so as to suppress density deterioration caused by repetitive use in an image forming apparatus in which charging is carried out using a contact charging method in which only a direct voltage is applied, but an erasing device is not used for erasing.

In addition, in the configuration of the undercoat layer of the electrophotographic photoreceptor, together with the metallic oxide particles, the electron-accepting compound having an anthraquinone structure is included in an amount as large as 1 part by weight to 5 parts by weight with respect to 100 parts by weight of the metallic oxide particles.

Thereby, it is considered that in the undercoat layer of the electrophotographic photoreceptor, the progress of the corrosion of the conductive substrate due to an oxidation and reduction reaction between the coupling agent having an amino group and the conductive substrate is suppressed, and, as a result, occurrence of ghost is suppressed.

Therefore, it is considered that, in the image forming apparatus according to the exemplary embodiment, the high contrast properties of an image are maintained, occurrence of fogging of an image is suppressed, a decrease in the image density due to repetitive use is suppressed, and occurrence of ghost is suppressed.

In addition, while the action mechanism is not evident, it is considered that use of a material having a hydroxyanthraquinone structure as the electron-accepting compound further suppresses occurrence of ghost.

Hereinafter, each of the members in the image forming apparatus of the exemplary embodiment will be described in detail.

Electrophotographic Photoreceptor

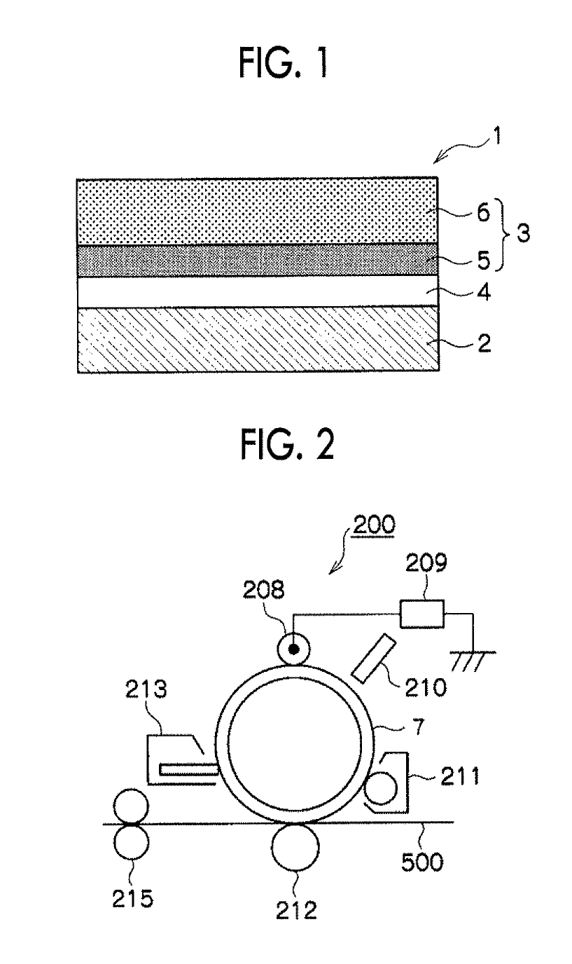

FIG. 1 schematically shows a cross-section of a part of the electrophotographic photoreceptor according to the exemplary embodiment. An electrophotographic photoreceptor 1 shown in FIG. 1 has, for example, a function separation-type photosensitive layer 3 that is separately provided with a charge generation layer 5 and a charge transport layer 6, and has a structure in which an undercoat layer 4, the charge generation layer 5, and the charge transport layer 6 are laminated sequentially on a conductive substrate 2.

Meanwhile, in the present specification, insulation means that the volume resistivity is in a range of 10¹² Ωm or more. On the other hand, conductivity means that the volume resistivity is in a range of 10¹⁰ Ωm or less.

Hereinafter, the respective elements of the photoreceptor 1 will be described.

Conductive Substrate

Any conductive substrates may be used as the conductive substrate 2 as long as they have thus far been used. Examples thereof include a metal, such as aluminum, nickel, chromium, or stainless steel; plastic films provided with a thin film of aluminum, titanium, nickel, chromium, stainless steel, gold, vanadium, tin oxide, indium oxide, or ITO; and paper, plastic films, and the like having a conductivity-imparting agent coated thereon or impregnated therein.

The shape of the conductive substrate 2 is not limited to a drum shape, and may be a sheet shape or a plate shape.

In a case in which a metal pipe is used as the conductive substrate 2, the pipe may have a pure surface as it is, or have a surface that has been treated with treatment, such as mirror cutting, etching, anode oxidation, rough cutting, centerless grinding, sand blasting, and wet honing, in advance.

Undercoat Layer

The undercoat layer 4 contains at least the metallic oxide particles and a specific electron-accepting compound, and may include other materials according to necessity.

Examples of the undercoat layer 4 include a layer formed by dispersing the metallic oxide particles and the specific electron-accepting compound in a binder resin.

Metallic Oxide Particles

Examples of the metallic oxide particles include zinc oxide, titanium oxide, tin oxide, zirconium oxide, and the like, and may be used in mixture of two or more kinds.

The volume average particle diameter of the metallic oxide particles is, for example, 50 nm to 200 nm, preferably 60 nm to 180 nm, and more preferably 70 nm to 120 nm.

Meanwhile, the volume average particle diameter of the metallic oxide particles is measured using, for example, a laser diffraction particle size distribution measuring device (LA-700: manufactured by Horiba Ltd.). During measurement, a sample in a dispersion liquid state is adjusted so as to be 2 g in terms of solid content, and ion exchange water is added to the dispersion liquid so as to prepare 40 ml of the solution. The solution is put into a cell until it reaches an appropriate density, and the volume average particle diameter is measured after 2 minutes. The volume average particle diameters of the respective obtained channels are accumulated from the smaller diameter, and the volume average particle diameter at 50% accumulation is used as the volume average particle diameter.

The content of the metallic oxide particles included in the undercoat layer 4 is, for example, in a range of 2.5% by weight or more with respect to the total undercoat layer, preferably in a range of 10% by weight to 70% by weight, and more preferably in a range of 30% by weight to 50% by weight.

The metallic oxide particles have been surface-treated with a coupling agent containing an amino group.

Examples of the coupling agent containing an amino group include a silane coupling agent, a titanate coupling agent, an aluminum coupling agent, a surfactant, and the like. Particularly, a surface treatment agent in which fogging is suppressed by adjusting the resistance includes a silane coupling agent.

The silane coupling agent is an organic silane compound (organic compound containing a silicon atom), and specific examples thereof include γ-aminopropyl triethoxysilane, N,N-bis(β-hydroxyethyl)-γ-aminopropyl triethoxysilane, N-2-(aminoethyl)-3-aminopropyl trimethoxysilane, N-2-(aminoethyl)-3-aminopropyl methyl dimethoxysilane, N-phenyl-3-aminopropyl trimethoxysilane, and the like.

Whether or not the metallic oxide particles have been surface-treated with the coupling agent containing an amino group is confirmed through analysis of the molecular structure using FT-IR, Raman spectrometric method, XPS, or the like.

The method of the surface treatment of the metallic oxide particles is not particularly limited, and examples thereof include a dry method and a wet method.

In a case in which the surface treatment is carried out using a dry method, for example, while the metallic oxide particles are stirred using a mixer or the like having a large shear force, a surface treatment agent is directly added dropwise, or a surface treatment agent dissolved in an organic solvent is added dropwise, and the surface treatment agent is sprayed together with dry air or nitrogen gas. Dropwise addition or spraying is carried out at a temperature that is, for example, the boiling point of a solvent or lower. After the dropwise addition or spraying, the surface treatment agent may be heated to 100° C. or higher so as to be baked.

In the wet method, for example, the metallic oxide particles are stirred in a solvent, dispersed using ultrasonic waves, a sand mill, attritor, a ball mill, or the like, a surface treatment agent solution is added, stirred or dispersed, and then the solvent is removed. Examples of a method of removing the solvent include filtration and distillation. After removal of the solvent, the metallic oxide particles may be, furthermore, baked at 100° C. or higher. In the wet method, moisture in the metallic oxide particles may be removed before the surface treatment agent is added, and examples thereof include, for example, a method in which the moisture in the metallic oxide particle is removed while being stirred and heated in a solvent used for the surface treatment agent solution and a method in which the moisture in the metallic oxide particles is boiled with the solvent so as to be removed.

The amount of the surface treatment agent attached to the surfaces of 100 parts by weight of the metallic oxide particles (hereinafter sometimes referred to as the “surface treatment amount”) includes, for example, an amount of 0.5 part by weight to 3 parts by weight, is preferably 0.5 part by weight to 2.0 parts by weight, and more preferably 0.75 part by weight to 1.30 parts by weight.

Examples of the method of measuring the surface treatment amount (that is, the amount of the surface treatment agent attached to the metallic oxide particles) include a method in which the molecular structure is analyzed using FT-IR, Raman spectrometric method, XPS, or the like.

Electron-Accepting Compound

The electron-accepting compound is an electron-accepting compound having an anthraquinone structure as described above. Here, the “compound having an anthraquinone structure” is specifically at least one kind selected from anthraquinone and anthraquinone derivatives, and, more specifically, is preferably a compound represented by formula (1).

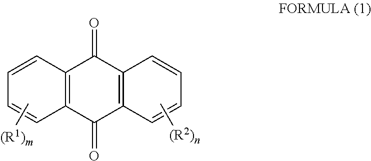

In formula (1), R¹ and R² each independently represents a hydroxyl group, a methyl group, a methoxy methyl group, a phenyl group, or an amino group, and m and n each independently represents an integer of from 0 to 4.

Meanwhile, in formula (1), a compound for which m and n are both 0 is anthraquinone, and, in formula (1), a compound for which at least one of m and n is an integer of from 1 to 4 is an anthraquinone derivative. That is, the anthraquinone derivative refers to a compound in which at least one of hydrogen atoms included in anthraquinone is substituted with a substituent, such as a hydroxyl group, a methyl group, a methoxy methyl group, a phenyl group, or an amino group.

Among the above, particularly preferable examples of the electron-accepting compound includes anthraquinone for which m and n are both 0 in formula (1), and hydroxyanthraquinone for which R¹ is a hydroxyl group, m is an integer of from 1 to 3, and n is 0.

Specific examples of the electron-accepting compound include anthraquinone, purpurin, alizarin, quinizarin, ethyl anthraquinone, amino hydroxyanthraquinone, and the like.

Whether or not the undercoat layer 4 contains the electron-accepting compound having an anthraquinone structure is confirmed through an analysis method, such as gas chromatography, liquid chromatography, FT-IR, Raman spectrometric method, XPS, or the like.

The content of the electron-accepting compound included in the undercoat layer 4 is 1 part by weight to 5 parts by weight with respect to 100 parts by weight of the metallic oxide particles included in the undercoat layer 4, and is preferably 2 parts by weight to 4 parts by weight.

The content ratio between the metallic oxide particles and the electron-accepting compound which are included in the undercoat layer 4 of the electrophotographic photoreceptor is confirmed through an analysis method, such as NMR spectrum, XPS, atomic absorption spectrometry, electron beam micro analyzer, or the like.

Binder Resin

As binder resins included in the undercoat layer 4, polymer compounds, such as acetal resins, polyvinyl butyral, polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic acid anhydride resins, silicone resins, silicone-alkyd resins, phenol resins, phenol-formaldehyde resins, melamine resins, or urethane resins; charge-transporting resins having a charge-transporting group; conductive resins, such as polyanilines; or the like may be used.

The content of the binder resin included in the undercoat layer is in a range of 5% by weight to 60% by weight with respect to the entire undercoat layer, is preferably 10% by weight to 55% by weight, and more preferably 30% by weight to 50% by weight.

Other Additives

Resin particles may be added to the undercoat layer 4 in order to adjust the surface roughness. Examples of the resin particles include silicone resin particles, crosslinked PMMA resin particles, and the like.

In addition, the surface of the undercoat layer 4 may be polished in order to adjust the surface roughness. Examples of the polishing method include buffing, a sand blasting treatment, wet honing, a grinding treatment, and the like.

Furthermore, a curing agent or a curing catalyst may be added to the undercoat layer 4. When a curing agent or a curing catalyst is added, a curing reaction is sufficiently caused so that unnecessary elution from the undercoat layer 4 is suppressed, and an increase in residual potential or a decrease in sensitivity is suppressed.

Examples of the curing agent include blocked isocyanate compounds, melamine resins, and the like, and blocked isocyanate compounds are preferably used. Since the isocyanate group is masked using a blocking agent in the blocked isocyanate compounds, a coating solution gelating over time so as to be more viscous is suppressed, and workability is excellent.

The curing catalyst includes generally used well-known materials, and, among the above, the curing catalyst is preferably selected from acid catalysts, amine-based catalysts, and metallic compound-based catalysts. Meanwhile, in a case in which a melamine resin is used as the curing agent, an acid catalyst is preferably used, and, in a case in which a blocked isocyanate compound is used as the curing agent, an amine-based catalyst or a metallic compound-based catalyst is preferably used. Examples of the metallic compound-based catalyst include stannous oxide, dioctyltin dilaurate, dibutyltin dilaurate, dibutyltin diacetate, zinc naphthenate, antimony trichloride, potassium oleate, sodium O-phenyl phenate, bismuth nitrate, ferric chloride, tetra-n-butyltin, tetra(2-ethylhexyl)titanate, cobalt 2-ethylhexanoate, ferric-ethylhexanoate, and the like.

The amount of the curing catalyst added is preferably 0.0001% by weight to 0.1% by weight, and more preferably 0.001% by weight to 0.01% by weight with respect to the curing agent.

Preparation of the Undercoat Layer

When the undercoat layer 4 is formed, a coating solution in which the above components are added to a solvent (the undercoat layer-forming coating solution) is used.

Examples of the solvent include organic solvents, and specific examples include aromatic hydrocarbon-based solvents, such as toluene and chlorobenzene; aliphatic alcohol-based solvents, such as methanol, ethanol, n-propanol, iso-propanol, and n-butanol; ketone-based solvents, such as acetone, cyclohexanone, and 2-butanone; halogenated aliphatic hydrocarbon solvents, such as methylene chloride, chloroform, and ethylene chloride; cyclic or linear ether-based solvents, such as tetrahydrofuran, dioxane, ethylene glycol, and diethyl ether; ester-based solvents, such as methyl acetate, ethyl acetate, and n-butyl acetate; and the like. The solvent may be used singly or in mixture of two or more kinds. The solvent is not particularly limited, but a solvent that dissolves the binder resin is preferably used.

The amount of the solvent used in the undercoat layer-forming coating solution is not particularly limited as long as the binder resin may be dissolved, and examples thereof include 0.05 part by weight to 200 parts by weight with respect to 1 part by weight of the binder resin.

In the method of dispersing the metallic oxide particles in the undercoat layer-forming coating solution, for example, a media disperser, such as a ball mill, a vibration ball mill, an attritor, or a sand mill; a media-less disperser, such as a stirrer, an ultrasonic disperser, a roll mill, or a high-pressure homogenizer; or the like is used. In addition, when a high-pressure homogenizer is used, a collision method in which a dispersion liquid is dispersed through liquid-liquid collision or liquid-wall collision in a high-pressure state, a penetration method in which a dispersion liquid is made to penetrate a fine flow path in a high-pressure state so as to be dispersed, or the like may be used.

In order to obtain a volume resistivity of the obtained undercoat layer 4 in the range described below, it is desirable to select an appropriate dispersion method, and, specifically, a sand mill using glass beads, a ball mill, or the like is preferably used for dispersion. The particle diameter of the glass beads is adjusted in accordance with the components of the metallic oxide particles, the binder resin, and the like being used, and, specifically, is 0.1 mm to 10 mm.

Examples of a method of coating the undercoat layer-forming coating solution on the conductive substrate 2 include a dip coating method, an extrusion coating method, a wire bar coating method, a spray coating method, a blade coating method, a knife coating method, a curtain coating method, and the like.

After the undercoat layer-forming coating solution is coated on the conductive substrate 2, it is preferable to carry out heating for drying or curing. The curing temperature and the heating time in a case in which a curing agent or a curing catalyst is used are desirably adjusted in accordance with the kind of the curing agent or the curing catalyst used, and a specific example is to carry out heating at a temperature of 160° C. to 200° C. for 15 minutes to 40 minutes.

Properties of the Undercoat Layer

The thickness of the undercoat layer 4 is desirably m or more, and more desirably 15 μm to 40 μm.

The volume resistivity of the undercoat layer 4 is, in measurement through an alternating current impedance method, in a range of 1.0×10⁹ Ωm to 1.0×10¹⁰ Ωam, and preferably in a range of 1.8×10⁹ Ωm to 8.6×10⁹ Ωm.

A detailed method of measuring the volume resistivity of the undercoat layer 4 is as follows.

Firstly, the alternating-current impedance of the undercoat layer 4 is measured. An alternating voltage of 1 V p-p is applied in a frequency range of 1 MHz to 1 mHz from the high frequency side using a conductive substrate, such as an aluminum pipe, in an impedance measurement sample as an anode and a gold electrode as a cathode, and the alternating impedances of the respective samples are measured. A graph of Cole-Cole plot obtained through the above measurement is fitted to a parallel RC equivalent circuit, thereby obtaining a volume resistivity of the undercoat layer 4.

Meanwhile, a method of manufacturing an undercoat layer sample for volume resistivity measurement from an electrophotographic photoreceptor is as follows.

For example, coating films that coat the undercoat layer, such as the charge generation layer and the charge transport layer, are removed using a solvent, such as acetone, tetrahydrofuran, methanol, or ethanol, and a gold electrode is mounted on the exposed undercoat layer through a vacuum deposition method or a sputtering method, thereby preparing an undercoat layer sample for volume resistivity measurement.

Examples of a method of adjusting the volume resistivity of the undercoat layer 4 in the above range include a method in which the addition amount or particle diameter of the metallic oxide particles is adjusted, or the method of dispersing the metallic oxide particles in the undercoat layer-forming coating solution is changed.

There is a tendency of the volume resistivity of the undercoat layer 4 decreasing as the particle diameter of the metallic oxide particles increases. In addition, there is a tendency of the volume resistivity of the undercoat layer 4 increasing as the addition amount of the metallic oxide particles increases.

In addition, when the dispersibility of the metallic oxide particles in the undercoat layer-forming coating solution is improved, there is a tendency of the volume resistivity of the undercoat layer 4 increasing. Specifically, there is a tendency of the volume resistivity of the undercoat layer 4 increasing as the dispersion treatment time of the undercoat layer-forming coating solution increases.

Intermediate Layer

For electric characteristic improvement, image quality improvement, image quality durability improvement, photosensitive layer adhesiveness improvement, and the like, an intermediate layer (not shown) may be further provided on the undercoat layer 4 as necessary. A binder resin used in the intermediate layer includes organic metallic compounds containing zirconium, titanium, aluminum, manganese, silicon atoms, or the like as well as polymer resin compounds including acetal resins, such as polyvinyl butyral; polyvinyl alcohol resins, casein, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic acid anhydride resins, silicone resins, silicone-alkyd resins, phenol-formaldehyde resins, and melamine resins.

For formation of the intermediate layer, for example, a coating solution having the binder resin dissolved in a solvent is used. As a method of coating the coating solution, a well-known method, such as a dip coating method, a extrusion coating method, a wire bar coating method, a spray coating method, a blade coating method, a knife coating method, or a curtain coating method, is used.

The thickness of the intermediate layer is set, for example, in a range of 0.1 μm to 3 μm.

Charge Generation Layer

The charge generation layer 5 is formed by, for example, dispersing a charge-generating material in the binder resin.

Examples of the charge-generating material used include phthalocyanine pigments, such as metal-free phthalocyanine, chlorogallium phthalocyanine, hydroxygallium phthalocyanine, dichlorotin phthalocyanine, and titanyl phthalocyanine, and, particularly, a chlorogallium phthalocyanine crystal having strong diffraction peaks at Bragg angles (2θ±0.2°) with respect to CuKα characteristic X-rays of at least 7.4°, 16.6°, 25.5°, and 28.3°, a metal-free phthalocyanine crystal having strong diffraction peaks at Bragg angles (2θ±0.2°) with respect to CuKα characteristic X-rays of at least 7.7°, 9.3°, 16.9°, 17.5°, 22.4°, and 28.8°, a hydroxygallium phthalocyanine crystal having strong diffraction peaks at Bragg angles (2θ±0.2°) with respect to CuKα characteristic X-rays of at least 7.5°, 9.9°, 12.5°, 16.3°, 18.6°, 25.1°, and 28.3°, a titanyl phthalocyanine crystal having strong diffraction peaks at Bragg angles (2θ±0.2°) with respect to CuKα characteristic X-rays of at least 9.6°, 24.1°, and 27.2°, and the like are used. In addition, a quinone pigment, a perylene pigment, an indigo pigment, a bisbenzimidazole pigment, an anthrone pigment, a quinacridone resin, and the like are used as the charge-generating material. The charge-generating material is used singly or in mixture of two or more kinds.

Examples of a binder resin used in the charge generation layer 5 include polycarbonate resins, such as bisphenol A or bisphenol Z polycarbonate resins, acrylic resins, methacrylic resins, polyarylate resins, polyester resins, polyvinyl chloride resins, polystyrene resins, acrylonitrile-styrene copolymer resins, acrylonitrile-butadiene copolymers, polyvinyl acetate resins, polyvinyl formal resins, polysulfone resins, styrene-butadiene copolymer resins, vinylidene chloride-acrylonitrile copolymer resins, vinyl chloride-vinyl acetate copolymer resins, vinyl chloride-vinyl acetate-maleic acid anhydride resins, silicone resins, phenol-formaldehyde resins, polyacryl amide resins, polyamide resins, poly-N-vinylcarbazole resins, and the like. The binder resin may be used singly or in mixture of two or more kinds.

The mixing ratio (weight ratio) of the charge-generating material and the binder resin is dependent on materials being used, and is, for example, in a range of 10:1 to 1:10.

When the charge generation layer 5 is formed, a coating solution in which the above components are added to a solvent is used.

In order to disperse the charge-generating material in the binder resin, a dispersion treatment is carried out on the dispersion liquid. As a dispersion unit, a media disperser, such as a ball mill, a vibration ball mill, an attritor, or a sand mill; a media-less disperser, such as a stirrer, an ultrasonic disperser, a roll mill, or a high-pressure homogenizer; or the like is used. Furthermore, when a high-pressure homogenizer is used, a collision method in which a dispersion liquid is dispersed through liquid-liquid collision or liquid-wall collision in a high-pressure state, a penetration method in which a dispersion liquid is made to penetrate a fine flow path in a high-pressure state so as to be dispersed, or the like may be used.

Examples of a method of coating the charge generation layer-forming coating solution obtained in the above manner on the undercoat layer 4 include a dip coating method, an extrusion coating method, a wire bar coating method, a spray coating method, a blade coating method, a knife coating method, a curtain coating method, and the like.

The thickness of the charge generation layer 5 is desirably set in a range of 0.01 μm to 5 μm.

Charge Transport Layer

The charge transport layer 6 is formed by, for example dispersing a charge-transporting material in the binder resin.

Examples of the charge-transporting material include hole-transporting substances, such as oxadiazole derivatives, such as 2,5-bis(p-diethylaminophenyl)-1,3,4-oxadiazole; pyrazoline derivatives, such as 1,3,5-triphenyl-pyrazoline and 1-[pyridyl-(2)]-3-(p-diethylaminostyryl)-5-(p-diethylaminostyryl)pyrazoline; aromatic tertiary amino compounds, such as triphenylamine, N,N′-bis(3,4-dimethylphenyl)biphenyl-4-amine, tri(p-methylphenyl)aminyl-4-amine, and dibenzylaniline; aromatic tertiary diamino compounds, such as N,N′-bis(3-methyphenyl)-N,N′-diphenylbenzidine, and N,N′-diphenyl-N,N′-bis(3-methylphenyl)-[1,1]′biphenyl-4,4′-diamine; 1,2,4-triazine derivatives, such as 3-(4′-dimethylaminophenyl)-5,6-di-(4′-methoxyphenyl)-1,2,4-triazine; hydrazone derivatives, such as 4 diethylaminobenzaldehyde-1,1-diphenylhydrazone; quinazoline derivatives, such as 2-phenyl-4-styryl-quinazoline; benzofuran derivatives, such as 6-hydroxy-2,3-di(p-methoxyphenyl)benzofuran; α-stilbene derivatives, such as p-(2,2-diphenylvinyl)-N,N-dipenylaniline; enamine derivatives; carbazole derivatives, such as N-ethylcarbozole; poly-N-vinylcarbazole and derivatives thereof, electron-transporting substances, such as quinone-based compounds, such as chloranile and broanthraquinone; tetracyanoquinodimethane-based compounds; fluorenone compounds, such as 2,4,7-trinitrofluorenone and 2,4,5,7-tetranitro-9-fluoroenone; xanthone-based compounds; and thiophene compounds, polymers having a group composed of the above compound in the main chain or the side chain, and the like. The charge-transporting material is used singly or in combination of two or more kinds.

Examples of a binder resin in the charge transport layer 6 include insulating resins, such as biphenyl copolymerization polycarbonate resins, polycarbonate resins, such as bisphenol A or bisphenol Z polycarbonate resins, acrylic resins, methacrylic resins, polyarylate resins, polyester resins, polyvinyl chloride resins, polystyrene resins, acrylonitrile-styrene copolymer resins, acrylonitrile-butadiene copolymer resins, polyvinyl acetate resins, polyvinyl formal resins, polysulfone resins, styrene-butadiene copolymer resins, vinylidene chloride-acrylonitrile copolymer resins, vinyl chloride-vinyl acetate-maleic acid anhydride resins, silicone resins, phenol-formaldehyde resins, polyacryl amide resins, polyamide resins, and chlorine rubber; organic photoconductive polymers, such as polyvinyl carbozole, polyvinyl anthracene, and polyvinylpyrene; and the like. The binder resin may be used singly or in mixture of two or more kinds.

In addition, in a case in which the charge transport layer 6 forms the surface layer (a layer of the photosensitive layer disposed farthest from the conductive substrate 2) of the electrophotographic photoreceptor, the charge transport layer 6 may contain lubricating particles (for example, silica particles, alumina particles, fluororesin particles, such as polytetrafluoroethylene (PTFE), silicone-based resin particles). The lubricating particles may be used in mixture of two or more kinds.

Furthermore, in a case in which the charge transport layer 6 forms the surface layer of the electrophotographic photoreceptor, fluorine-modified silicone oil may be added to the charge transport layer 6. Examples of the fluorine-modified silicone oil include compounds having a fluoroalkyl group.

Meanwhile, the weight ratio of the charge-transporting material and the binder resin in the charge transport layer 6 is, for example, in a range of 10:1 to 1:5. That is, the content of the charge-transporting material with respect to the entire charge transport layer 6 is, for example, in a range of 17% by weight to 91% by weight.

The charge transport layer 6 is formed using a charge transport layer-forming coating solution in which the above components are added to a solvent.

As the solvent, for example, a well-known organic solvent, such as an aromatic hydrocarbon-based solvent, such as toluene and chlorobenzene; an aliphatic alcohol-based solvent, such as methanol, ethanol, n-propanol, iso-propanol, and n-butanol; a ketone-based solvent, such as acetone, cyclohexanone, and 2-butanone; a halogenated aliphatic hydrocarbon solvent, such as methylene chloride, chloroform, and ethylene chloride; a cyclic or linear ether-based solvent, such as tetrahydrofuran, dioxane, ethylene glycol, and diethyl ether; an ester-based solvent, such as methyl acetate, ethyl acetate, and n-butyl acetate; or the like is used. In addition, the solvent may be used singly or in mixture of two or more kinds. The solvent being mixed and used is not limited as long as the solvent dissolves the binder resin as a solvent mixture.

In the method of dispersing the lubricating particles in the charge transport layer-forming coating solution, for example, a media disperser, such as a ball mill, a vibration ball mill, an attritor, or a sand mill; a media-less disperser, such as a stirrer, an ultrasonic disperser, a roll mill, a high-pressure homogenizer, or a nanomizer; or the like is used. In addition, when a high-pressure homogenizer is used, a collision method in which a dispersion liquid is dispersed through liquid-liquid collision or liquid-wall collision in a high-pressure state, a penetration method in which a dispersion liquid is made to penetrate a fine flow path in a high-pressure state so as to be dispersed, or the like may be used.

Examples of a method of forming the charge transport layer 6 include a method in which the charge transport layer-forming coating solution is coated and dried on the charge generation layer 5 of the conductive substrate 2 in which the undercoat layer 4 and the charge generation layer 5 are formed, thereby forming the charge generation layer 6.

Examples of a method of coating the charge transport layer-forming coating solution on the charge generation layer 5 include a dip coating method, an extrusion coating method, a wire bar coating method, a spray coating method, a blade coating method, a knife coating method, a curtain coating method, and the like.

In addition, after the coating solution is coated on the charge generation layer 5, the solvent in the coating solution is removed through a heating and drying process. The film thickness of the charge transport layer 6 is, for example, in a range of 5 μm to 50 μm.

In order to prevent deterioration of the photoreceptor due to ozone or nitrogen oxides generated in an image forming apparatus, light and heat, additives, such as an antioxidant, a light stabilizer, and a heat stabilizer, may be added to the respective layers that compose the photosensitive layer 3. Examples of the antioxidant include hindered phenol, hindered amine, paraphenylenediamine, arylalkane, hydroxyquinone, spirochromane, spiroindanone and derivatives thereof, organic sulfur compounds, organic phosphorous compounds, and the like. Examples of the light stabilizer include derivatives such as benzophenone, benzoazole, dithiocarbamate, and tetramethylpipene.

Meanwhile, in the photoreceptor 1 of the exemplary embodiment, the charge transport layer 6 forms the outermost surface layer, but the photoreceptor may have a configuration in which a protective layer is further formed on the charge transport layer.

Image Forming Apparatus

Next, an image forming apparatus having the electrophotographic photoreceptor according to the exemplary embodiment will be described.

### First Exemplary Embodiment

FIG. 2 schematically shows the basic configuration of an image forming apparatus of a first exemplary embodiment.

An image forming apparatus 200 shown in FIG. 2 has, for example, the electrophotographic photoreceptor 1 of the exemplary embodiment, a contact charging-type charging device 208 (charging unit) that is connected to a power supply 209 and charges the electrophotographic photoreceptor 1, an exposing device 210 (electrostatic latent image forming unit) that exposes the electrophotographic photoreceptor 1 charged using the charging device 208 so as to form an electrostatic latent image, a developing device 211 (developing unit) that develops the electrostatic latent image formed using the exposing device 210 using a developer including a toner so as to form a toner image, a transferring device 212 (transferring unit) that transfers the toner image formed on the surface of the electrophotographic photoreceptor 1 to a recording medium 500, a toner-removing device 213 (toner-removing unit) that, after transferring, removes the toner remaining on the surface of the electrophotographic photoreceptor 1, and a fixing device 215 (fixing unit) that fixes the toner image transferred to the recording medium 500 to the recording medium 500.

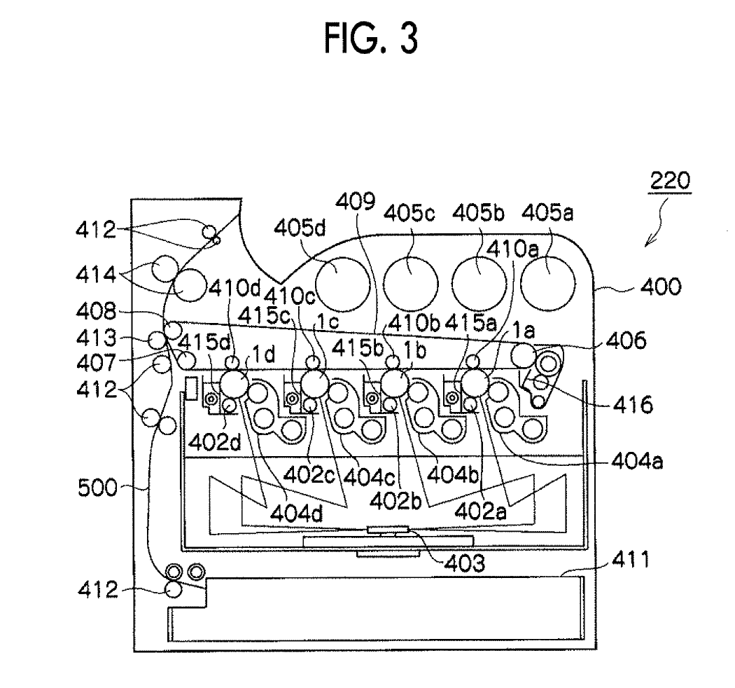

In addition, the image forming apparatus 200 shown in FIG. 3 is an eraseless-type image forming apparatus that does not have an erasing unit that removes electric charges remaining on the surface of the electrophotographic photoreceptor after the toner image on the surface of the electrophotographic photoreceptor is transferred.

The charging device 208 has a charging member, and a voltage is applied to the charging member when the photoreceptor 1 is charged. With regard to the range of the voltage, since only a direct voltage is applied in the exemplary embodiment, the voltage being applied is a direct voltage of positive or negative 50 V to 2000 V (preferably 250 V to 1000 V, and more preferably 350 V to 750 V) according to the demanded charging potential of the electrophotographic photoreceptor 1.

Examples of the charging member include a roller, a brush, a film, and the like, and, among the above, a roller-shape charging member (hereinafter sometimes referred to as the “charging roller”) which is composed of a material having an electrical resistance adjusted to a range of 10³Ω to 10⁸Ω is exemplified. In addition, the charging roller may be composed of a single layer or plural layers.

In a case in which the charging roller is used as the charging member, the pressure at which the charging roller is brought into contact with the photoreceptor 1 is, for example, in a range of 250 mgf to 600 mgf.

As a material that composes the charging member, a material in which a main material of elastomer composed of, for example, a synthetic rubber, such as urethane rubber, silicone rubber, fluorine rubber, chloroprene rubber, butadiene rubber, ethylene-propylene-diene (EPDM) copolymer rubber, or epichlorohydrin rubber, polyolefin, polystyrene, vinyl chloride, or the like is mixed with an appropriate amount of a conductivity-imparting agent, such as a conductive carbon, a metallic oxide, or an ion conducting agent is used.

Furthermore, a material obtained by making a resin, such as nylon, polyester, polystyrene, polyurethane, or silicone, into a coating material, mixing the coating material with an appropriate amount of a conductivity-imparting agent, such as a conductive carbon, a metallic oxide, or an ion conducting agent, and laminating the obtained coating material through a method of dipping, spraying, roll coating, or the like may be used.

In a case in which the charging roll is used as the charging member, since the charging roll is brought into contact with the surface of the photoreceptor 1, the charging unit rotates in conjunction with the photoreceptor 1 even without a driving unit, but the charging unit may rotate at a different circumferential velocity from that of the photoreceptor 1 by attaching a driving unit to the charging roll.

A well-known exposing unit is used as the exposing device 210. Specifically, for example, an optical device with which the electrophotographic photoreceptor is exposed using a light source, such as a semiconductor laser, a light emitting diode (LED), or a liquid crystal shutter, is used. The amount of light during shedding is, for example, in a range of 0.5 mJ/m² to 5.0 mJ/m² on the surface of the photoreceptor.

Examples of the developing device 211 include a two-component developing-type developing unit in which a developing brush (developer-holding article) to which a developer including a carrier and a toner is attached is brought into contact with an electrostatic latent image-holding article so as to develop the electrostatic latent image, a contact-type single-component developing-type developing unit in which a toner is attached to a conductive rubber elastic article-transporting roll (developer-holding article) so as to develop the toner on the electrostatic latent image-holding article, and the like.

The toner is not particularly limited as long as the toner is a well-known toner. Specifically, the toner may be, for example, a toner that includes at least a binder resin, and includes a colorant, a release agent, and the like according to necessity.

A method of manufacturing the toner is not particularly limited, and examples thereof include an ordinary pulverizing method, a wet-type melt spheronization method in which a toner is manufactured in a dispersion medium, a method in which a toner is manufactured using a well-known polymerization method, such as suspension polymerization, dispersion polymerization, or an emulsification polymerization agglomeration method.

In a case in which the developer is a two-component developer including a toner and a carrier, the carrier is not particularly limited, and examples thereof include carriers (non-coated carriers) composed of a core material only, such as a magnetic metal, such as ferric oxide, nickel, or cobalt, or a magnetic oxide, such as ferrite or magnetite; resin-coated carriers having a resin layer provided on the surface of the core material; and the like. In a two-component developer, the mixing ratio (weight ratio) of the toner and the carrier is, for example, in a range of 1:100 to 30:100, and may be in a range of 3:100 to 20:100.

The transferring device 212 includes contact-type transferring chargers using a belt, a film, a rubber blade, or the like, scorotron transferring chargers and corotron transferring chargers using corona discharge, and the like as well as roller-shape contact-type charging members.

The toner-removing device 213 is to remove the residual toner attached to the surface of the electrophotographic photoreceptor 1 after a transferring process, and the electrophotographic photoreceptor 1 whose surface is cleaned using the toner-removing device is repeatedly provided to the image forming process. As the toner-removing device 213, a brush cleaner, a roll cleaner, or the like is used as well as a foreign substance-removing member (cleaning blade), and, among the above, a cleaning blade is desirably used. In addition, the cleaning blade is made of a urethane rubber, a neoprene rubber, a silicone rubber, or the like.

Meanwhile, in a case in which there is no problem with the residual toner, for example, a case in which it is difficult for the toner to remain on the surface of the photoreceptor 1, the toner-removing device 213 does not need to be provided.

The fundamental image-preparation process of the image forming apparatus 200 will be described.

Firstly, the charging device 208 charges the surface of the photoreceptor 1 to a predetermined potential. Next, the charged surface of the photoreceptor 1 is exposed using the exposing device 210 based on image signals so as to form an electrostatic latent image.

Next, a developer is held on the developer-holding article in the developing device 211, the held developer is transported to the photoreceptor 1, and supplied to the electrostatic latent image at a location where the developer-holding article and the photoreceptor 1 come close to each other (or contact with each other). Thereby, the electrostatic latent image is visualized so as to form a toner image.

The developed toner image is transported to the location of the transferring device 212, and directly transferred to the recording medium 500 using the transferring device 212.

Next, the recording medium 500 to which the toner image has been transferred is transported to the fixing device 215, and the toner image is fixed to the recording medium 500 using the fixing device 215. The fixing temperature is, for example, 100° C. to 180° C.

Meanwhile, after the toner image is transferred to the recording medium 500, toner particles which are not transferred and, instead, remain in the photoreceptor 1 are moved to the contact location with the toner-removing device 213, and collected using the toner-removing device 213.

In the above manner, an image is formed using the image forming apparatus 200.

### Second Exemplary Embodiment

FIG. 3 schematically shows the basic configuration of an image forming apparatus of a second exemplary embodiment. The image forming apparatus 220 shown in FIG. 3 is an intermediate transfer-type image forming apparatus, and has 4 electrophotographic photoreceptors 1a, 1b, 1c, and 1d disposed in parallel along an intermediate transferring belt 409 in a housing 400. For example, the photoreceptor 1a forms yellow images, the photoreceptor 1b forms magenta images, the photoreceptor 1c forms cyan images, and the photoreceptor 1d forms black images, respectively.

In addition, the image forming apparatus 220 shown in FIG. 3 is an eraseless-type image forming apparatus that does not have an erasing unit that removes electric charges remaining on the surface of the electrophotographic photoreceptor after the toner image on the surface of the electrophotographic photoreceptor is transferred.

Here, the electrophotographic photoreceptors 1a, 1b, 1c, and 1d mounted in the image forming apparatus 220 are the electrophotographic photoreceptor of the exemplary embodiment, respectively.

The electrophotographic photoreceptors 1a, 1b, 1c, and 1d rotate in a single direction (counterclockwise on the drawing) respectively, and charging rolls 402a, 402b, 402c, and 402d; developing devices 404a, 404b, 404c, and 404d; primary transferring rolls 410a, 410b, 410c, and 410d; and cleaning blades 415a, 415b, 415c, and 415d are disposed in the rotating direction. The developing devices 404a, 404b, 404c, and 404d supply four color toners of black, yellow, magenta, and cyan toners accommodated in toner cartridges 405a, 405b, 405c, and 405d, and, the primary transferring rolls 410a, 410b, 410c, and 410d are in contact with the electrophotographic photoreceptors 1a, 1b, 1c, and 1d respectively through the intermediate transferring belt 409.

Furthermore, a laser beam source (exposing device) 403 is disposed in the housing 400, and the charged surfaces of the electrophotographic photoreceptors 1a, 1b, 1c, and 1d are irradiated with laser beams emitted from the laser beam source 403. Thereby, the respective processes of charging, exposing, developing, primary transferring, and cleaning (removal of foreign substances, such as the toner) are sequentially carried out during the rotating process of the electrophotographic photoreceptors 1a, 1b, 1c, and 1d, and toner images of the respective colors are overlapped on the intermediate transferring belt 409, and transferred. In addition, the electrophotographic photoreceptors 1a, 1b, 1c, and 1d that have transferred the toner images to the intermediate transferring belt 409 is subjected to the next image forming process without undergoing a process in which electric charges on the surface are removed.

The intermediate transferring belt 409 is tensionally supported by a driving roll 406, a back roll 408, and a supporting roll 407, and rotates without occurrence of deflection due to rotation of the rolls. In addition, a secondary transferring roll 413 is disposed so as to contact the back roll 408 through the intermediate transferring belt 409. The intermediate transferring belt 409 penetrating the location sandwiched by the back roll 408 and the secondary transferring roll 413 is repeatedly provided for the next image forming process after the surface of the belt is cleaned using the cleaning blade 416 that is disposed, for example, opposite to the driving roll 406.

In addition, a container 411 that accommodates a recording medium is provided in the housing 400, and the recording medium 500, such as paper, in the container 411 is sequentially conveyed using a conveying roll 412 to the location sandwiched by the intermediate transferring belt 409 and the secondary transferring roll 413, and, furthermore, a location sandwiched by two mutually contacting fixing rolls 414, and then discharged outside the housing 400.

Meanwhile, in the above description, a case in which the intermediate transferring belt 409 is used as an intermediate transferring article has been described, but the intermediate transferring article may have a belt shape like the intermediate transferring belt 409 or a drum shape. In the case of the belt shape, a well-known resin is used as a resin material that constitutes the base material of the intermediate transferring article. Examples thereof include resin materials, such as polyimde resins, polycarbonate resins (PC), polyvinylidne fluoride (PVDF), polyalkylene terephthalate (PAT), blend materials of ethylene tetrafluoroethylene copolymers (ETFE)/PC, ETFE/PAT and PC/PAT, polyester, polyether ether ketone, and polyamide; and resin materials mainly formed of the above materials. Furthermore, a resin material and an elastic material may be blended and used.

In addition, the recording medium in the exemplary embodiment is not particularly limited as long as the medium transfers toner images formed on the electrophotographic photoreceptors.

In addition, in the exemplary embodiment, the charging rolls 402a, 402b, 402c, and 402d employ a method in which only a direct voltage is applied.

Process Cartridge

The process cartridge according to the exemplary embodiment is detachable from the image forming apparatus according to the exemplary embodiment.

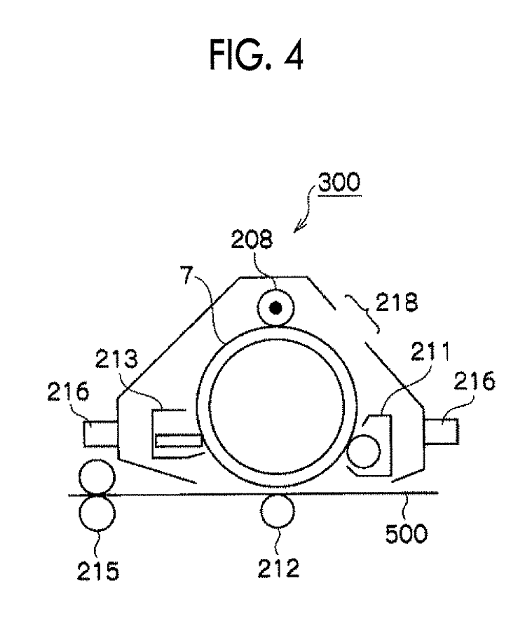

FIG. 4 schematically shows the basic configuration of an example of a process cartridge having the electrophotographic photoreceptor of the exemplary embodiment. In the process cartridge 300, together with the electrophotographic photoreceptor 1, a contact charging-type charging device 208 that charges the electrographic photoreceptor 1, a developing device 211 that develops electrostatic latent images formed on the electrophotographic photoreceptor 1 through exposure using a developer including a toner so as to form a toner image, a toner-removing device 213 that removes toner remaining on the surface of the electrophotographic photoreceptor 1 after transferring, and an opening 218 for exposure are combined using an attaching rail 216 so as to be integrated.

In addition, the process cartridge 300 is freely detachable from the main article of the image forming apparatus which is composed of the transferring device 212 that transfers toner images formed on the surface of the electrophotographic photoreceptor 1 to the recording medium 500, the fixing device 215 that fixes the toner images transferred to the recording medium 500, and other components, not shown, and composes the image forming apparatus with the main article of the image forming apparatus.

The process cartridge 300 may have an exposing device (not shown) that exposes the surface of the electrophotographic photoreceptor 1 as well as the electrophotographic photoreceptor 1, the charging device 208, the developing device 211, the toner-removing device 213, and the opening 213 for exposure.

Meanwhile, the process cartridge of the exemplary embodiment needs to have at least the electrophotographic photoreceptor 1 and the charging device 208.

### EXAMPLES

Hereinafter, the invention will be described specifically using examples, but the invention is not limited to the examples. Meanwhile, is based on weight unless otherwise described.

Manufacturing of an electrophotographic photoreceptor

### Example 1

### Preparation of an Undercoat Layer

Zinc oxide particles (60 parts by weight, manufactured by Tayca Corporation, volume average particle diameter: 70 nm, specific surface area value: 15 m²/g) are stirred and mixed with tetrahydrofuran (500 parts by weight), 1.25 parts by weight of KEM603 (N-2-(aminoethyl)-3-aminopropyltrimethoxysilane, manufactured by Shin-Etsu Chemical Co., Ltd.) is added with respect to 100 parts by weight of the zinc oxide particles as a silane coupling agent (surface treatment agent), and the resultant is stirred for 2 hours. After that, the tetrahydrofuran is removed through reduced-pressure distillation, and the resultant is baked at 120° C. for 3 hours, thereby obtaining zinc oxide particles having been surface-treated with the silane coupling agent.

A solution (38 parts by weight) in which the zinc oxide particles having been surface-treated with the silane coupling agent (100 parts by weight), anthraquinone (1 part by weight) as an electron-accepting compound, blocked isocyanate (22.5 parts by weight, SUMIDUR 3173, manufactured by Sumitomo Bayer Urethane Co., Ltd.) as a curing agent, and a butyral resin (25 parts by weight, S-LEC BM-1, manufactured by Sekisui Chemical Co., Ltd.) are dissolved in methyl ethyl ketone (142 parts by weight) is mixed with methyl ethyl ketone (25 parts by weight), and dispersed in a sand mill using 1 mm-diameter glass beads for 10 hours, thereby obtaining a dispersion liquid. Dioctyltin dilaurate (0.008 part by weight) and silicone resin particles (6.5 parts by weight, TOSPEARL 145, manufactured by GE Toshiba Silicones Co., Ltd.) are added to the obtained dispersion liquid as catalysts, thereby obtaining an undercoat layer-forming coating solution. The coating solution is coated on a 30 mm-diameter aluminum substrate using a dip coating method, and dry-cured at 170° C. for 24 minutes, thereby obtaining a 15 μm-thick undercoat layer.

Preparation of a Charge Generation Layer

Next, a mixture composed of a chlorogallium phthalocyanine crystal (15 parts by weight) having strong diffraction peaks at Bragg angles (2θ±0.2°) with respect to CuKα characteristic X-rays of at least 7.4°, 16.6°, 25.5°, and 28.3°, vinyl chloride-vinyl acetate copolymer resin (10 parts by weight, VMCH, manufactured by Union Carbide Japan KK) and n-butyl alcohol (300 parts by weight) is dispersed as a charge-generating material in a sand mill using 1 mm-diameter glass beads for 4 hours, thereby obtaining a charge generation layer-forming coating solution. The charge generation layer-forming coating solution is dip-coated, and dried on the undercoat layer, thereby obtaining a 0.2 μm-thick charge generation layer.

Preparation of a Charge Transport Layer

Next, tetrafluoroethylene resin particles (8 parts by weight, average particle diameter: 0.2 μm), a fluoroalkyl group-containing methacryl copolymer (0.015 part by weight, weight-average molecular weight: 30000), tetrahydrofuran (4 parts by weight), and toluene (1 part by weight) are kept at a liquid temperature of 20° C., stirred, and mixed for 48 hours, thereby obtaining a tetrafluoroethylene resin particle suspension A.

Next, N,N′-diphenyl-N,N′-bis(3-methylphenyl)-[1,1′]biphenyl-4,4′-diamine (4 parts by weight) and a bisphenol Z polycarbonate resin (6 parts by weight, viscosity average molecular weight: 40,000) as charge-transporting substances and 2,6-di-t-butyl-4-methylphenol (0.1 part by weight) as an antioxidant are mixed, tetrahydrofuran (24 parts by weight) and toluene (11 parts by weight) are mixed and dissolved, thereby obtaining a mixed solution B.

The tetrafluoroethylene resin particle suspension A is added to the mixed solution B, and the resultant is stirred, and mixed, and then, a dispersion treatment with a pressure increased to 4900 N/cm² (500 kgf/cm²) is repeated six times using a high-pressure homogenizer (manufactured by Yoshida Kikai Co., Ltd.) equipped with a penetration-type chamber having fine flow paths. Fluorine-modified silicone oil (trade name: FL-100, manufactured by Shin-Etsu Chemical Co., Ltd.) is added to the mixture until the content reaches 5 ppm and the resultant is stirred, thereby obtaining a charge transport layer-forming coating solution.

The coating solution is coated on the charge generation layer, and dried at 140° C. for 25 minutes so as to form a charge transport layer, thereby obtaining a 32.0 μm-thick electrophotographic photoreceptor 1.

### Example 2

An electrophotographic photoreceptor 2 is manufactured using the same method as in Example 1 except that 5 parts by weight the electron-accepting compound is dissolved, and the volume average particle diameter of the zinc oxide particles is set to 100 nm in the preparation of the undercoat layer.

### Example 3

An electrophotographic photoreceptor 3 is manufactured using the same method as in Example 2 except that 1 part by weight the electron-accepting compound is dissolved, and the dispersion time of the undercoat layer coating solution using a sand mill is set to 8 hours in the preparation of the undercoat layer.

### Example 4

An electrophotographic photoreceptor 4 is manufactured using the same method as in Example 2 except that 5 parts by weight the electron-accepting compound is dissolved, and the dispersion time of the undercoat layer coating solution using a sand mill is set to 5 hours in the preparation of the undercoat layer.

### Example 5

An electrophotographic photoreceptor 5 is manufactured using the same method as in Example 1 except that 3 parts by weight the electron-accepting compound is dissolved, and the dispersion time of the undercoat layer coating solution using a sand mill is set to 7 hours in the preparation of the undercoat layer.

### Example 6

An electrophotographic photoreceptor 6 is manufactured using the same method as in Example 5 except that purpurin is used as the electron-accepting compound in the preparation of the undercoat layer.

### Comparative Example 1

An electrophotographic photoreceptor C1 is manufactured using the same method as in Example 1 except that 2 parts by weight the electron-accepting compound is dissolved, and the dispersion time using a sand mill is set to 11 hours in the preparation of the undercoat layer.

### Comparative Example 2

An electrophotographic photoreceptor C2 is manufactured using the same method as in Example 2 except that 2 parts by weight the electron-accepting compound is dissolved, and the dispersion time using a sand mill is set to 6.5 hours in the preparation of the undercoat layer.

### Comparative Example 3

An electrophotographic photoreceptor C3 is manufactured using the same method as in Example 2 except that 6 parts by weight the electron-accepting compound is dissolved, and the dispersion time using a sand mill is set to 8 hours in the preparation of the undercoat layer.

### Comparative Example 4

An electrophotographic photoreceptor C4 is manufactured using the same method as in Example 2 except that 0.5 part by weight the electron-accepting compound is dissolved, and the dispersion time using a sand mill is set to 7.5 hours in the preparation of the undercoat layer.

Measurement Of the Resistivity of the Undercoat Layer

Preparation of Measurement Sample

The undercoat layer coating solutions used when the photoreceptors of the examples and the comparative examples are manufactured are coated on aluminum plates respectively using a blade coating method, and dry-cured at 170° C. for 24 minutes. A 100 nm gold electrode is mounted on a single layer film of the undercoat layer as an opposite electrode using a vacuum deposition method, and the resultant is used for measurement of resistivity.

Measurement Method

For measurement of impedance, an SI 1287 electrochemical interface (manufactured by Toyo Corporation) is used as a power supply, an SI 1260 impedance/gain phase analyzer (manufactured by Toyo Corporation) is used as an ammeter, and a 1296 dielectric interface (manufactured by Toyo Corporation) is used as an electric current amplifier.

An alternating voltage of 1 V p-p is applied in a frequency range of 1 MHz to 1 mHz from the high frequency side using an aluminum pipe in the impedance measurement sample as an anode and the gold electrode as a cathode, and the alternating-current impedances of the respective samples are measured. A graph of Cole-Cole plot obtained through the above measurement is fitted to a parallel RC equivalent circuit, thereby obtaining a volume resistivity. The volume resistivity of the examples and the comparative examples are shown in Table 1.

Evaluation

The electrophotographic photoreceptors 1 to 6 and the electrophotographic photoreceptors C1 to C4 which are obtained in the examples and the comparative examples are combined into a reformed image forming apparatus DocuCentre 505a. The present image forming apparatus is configured to apply a direct voltage of −600 V to the charging roll so as to charge the photoreceptors in a contact charging manner.

In addition, the following evaluation is carried out using the image forming apparatus.

Evaluation of Ghost in the Photoreceptors

The electrophotographic photoreceptors 1 to 6 and the electrophotographic photoreceptors C1 to C4 which are obtained in the examples and the comparative examples are combined into a reformed image forming apparatus DocuCentre 505a, and an arbitrary number of 15 mm×15 mm square patterns are printed around the electrophotographic photoreceptor as images for ghost evaluation under conditions of 10° C. and a humidity of 15%, then, a half-tone image (with an image density of 5%) is printed across the entire surface in the next cycle, and ghost images appeared on the half-tone image are evaluated based on the following standards. The results are shown in Table 1.

A: No ghost image may be visually confirmed.

B: Ghost occurs slightly, and may be confirmed visually.

C: Ghost occurs.

D: Ghost occurs significantly.

Evaluation of Image Quality Contrast in the Photoreceptors

The electrophotographic photoreceptors 1 to 6 and the electrophotographic photoreceptors C1 to C4 which are obtained in the examples and the comparative examples are combined into a reformed image forming apparatus DocuCentre 505a, and a solid image (Cin100%) is printed in the left half of paper in a process direction under conditions of a temperature of 20° C. and a humidity of 25%. The densities at the solid image portion and the non-image portion are measured using an X-Riter density-measuring device, and evaluated using the following standards. The results are shown in Table 1.

Not problematic: The density difference between the image portion and the non-image portion is 1.550 or more.

Problematic: The density difference between the image portion and the non-image portion is less than 1.550.

Evaluation of Fogging in the Photoreceptors

The electrophotographic photoreceptors 1 to 6 and the electrophotographic photoreceptors C1 to C4 which are obtained in the examples and the comparative examples are combined into a reformed image forming apparatus DocuCentre 505a, images are outputted under conditions of a temperature of 20° C. and a humidity of 25%, and the degrees of fogging are evaluated visually based on the following standards. The results are shown in Table 1.

A: No fogging occurs.

B: Fogging occurs slightly.

C: Fogging occurs.

D: Fogging occurs significantly.

Evaluation of image densities in the photoreceptors

The electrophotographic photoreceptors 1 to 6 and the electrophotographic photoreceptors C1 to C4 which are obtained in the examples and the comparative examples are combined into a reformed image forming apparatus DocuCentre 505a, and the states of images when half-tone images having an image density of 5% are formed on 50000 sheets of A3-size ordinary paper under conditions of a temperature of 28° C. and a humidity of 85% are shown in Table 1. The evaluation standards are as follows.

A: No density changes.

B: The density deteriorates slightly.

C: The density deteriorates.

D: The density deteriorates significantly.

TABLE 1

| | Undercoat layer | | | | | | | |
|---|---|---|---|---|---|---|---|---|
| | | | Amount of electron- | | | | | |
| | Volume average | | accepting compound (parts | | | | | |
| | particle diameter of | Coating solution | by weight with respect to | | Evaluation | | | |
| | metallic oxide | sand mill dispersion | 100 parts by weight of | Volume | | | | Image |
| | particles (nm) | time (h) | metallic oxide particles) | resistivity (Ωm) | Ghost | Contrast | Fogging | density |
| Example 1 | 70 | 10 | 1 | 9.9 × 10⁹ | B | Not problematic | B | B |
| Example 2 | 100 | 10 | 5 | 1.0 × 10¹⁰ | B | Not problematic | B | B |
| Example 3 | 100 | 8 | 1 | 1.0 × 10⁹ | B | Not problematic | B | B |
| Example 4 | 100 | 5 | 5 | 1.2 × 10⁹ | A | Not problematic | A | B |
| Example 5 | 70 | 7 | 3 | 5.5 × 10⁹ | A | Not problematic | A | A |
| Example 6 | 70 | 7 | 3 | 5.8 × 10⁹ | B | Not problematic | A | A |
| Comparative | 70 | 11 | 2 | 3.0 × 10¹⁰ | D | Problematic | C | D |
| example 1 | | | | | | | | |
| Comparative | 100 | 6.5 | 2 | 8.5 × 10⁸ | D | Not problematic | C | C |
| example 2 | | | | | | | | |
| Comparative | 100 | 8 | 6 | 8.0 × 10⁹ | C | Not problematic | B | C |
| example 3 | | | | | | | | |
| Comparative | 100 | 7.5 | 0.5 | 7.8 × 10⁸ | C | Problematic | D | D |
| example 4 | | | | | | | | |

It is found from the above evaluation results that the examples may obtain favorable results in all of the respective evaluations of ghost, contrast, fogging, and image density compared to the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an electrophotographic photoreceptor;
a charging unit that charges a surface of the electrophotographic photoreceptor through contact charging in which only direct voltage is applied;
an exposing unit that exposes a charged surface of the electrophotographic photoreceptor so as to form an electrostatic latent image;
a developing unit that develops the electrostatic latent image using a developer so as to form a toner image; and
a transferring unit that transfers the toner image to a recording medium,
and not having an erasing unit that erases the surface of the electrophotographic photoreceptor after the toner image is transferred to the recording medium using the transferring unit and before the surface of the electrographic photoreceptor is charged using the charging unit,
wherein the electrophotographic photoreceptor has an undercoat layer and a photosensitive layer on a conductive substrate,
the undercoat layer has metallic oxide particles having been surface-treated with a coupling agent containing an amino group and an electron-accepting compound having an anthraquinone structure,
the electron-accepting compound is included in a range of 1 part by weight to 5 parts by weight with respect to 100 parts by weight of the metallic oxide particles, and
a volume resistivity of the undercoat layer is in a range of 1.0×10⁹ Ωm to 1.0×10¹⁰ Ωm in a measurement through an alternating current impedance method.

2. The image forming apparatus according to claim 1,
wherein the electron-accepting compound is a compound represented by the following formula (1): 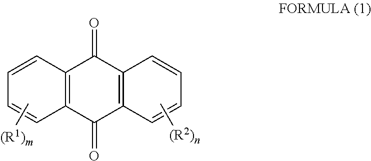
wherein in formula (1), R¹ and R² each independently represents a hydroxyl group, a methyl group, a methoxy methyl group, a phenyl group, or an amino group, and m and n each independently represents an integer of from 0 to 4.

3. The image forming apparatus according to claim 1,
wherein the electron-accepting compound is an electron-accepting compound having a hydroxyanthraquinone structure.

4. The image forming apparatus according to claim 1,
wherein a content of the electron-accepting compound is in a range of 2 parts by weight to 4 parts by weight with respect to 100 parts by weight of the metallic oxide particles contained in the undercoat layer.

5. The image forming apparatus according to claim 1,
wherein a volume average particle diameter of the metallic oxide particles is in a range of 50 nm to 200 nm.

6. The image forming apparatus according to claim 1,
wherein a content of the metallic oxide particles is in a range of 2.5% by weight to 70% by weight with respect to the entire undercoat layer.

7. The image forming apparatus according to claim 1,
wherein the coupling agent having an amino group is a compound selected from a group consisting of γ-aminopropyl triethoxysilane, N,N-bis(β-hydroxyethyl)-γ-aminopropyl triethoxysilane, N-2-(aminoethyl)-3-aminopropyl trimethoxysilane, N-2-(aminoethyl)-3-aminopropyl methyl dimethoxysilane, and N-phenyl-3-aminopropyl trimethoxysilane.

8. The image forming apparatus according to claim 1,
wherein a thickness of the undercoat layer is in a range of 10 μm to 40 μm.

9. The image forming apparatus according to claim 1,
wherein the volume resistivity of the undercoat layer is in a range of 1.8×10⁹ Ωm to 8.6×10⁹ Ωm in the measurement through the alternating current impedance method.

10. The image forming apparatus according to claim 1,
wherein the charging unit applies a direct voltage in a range of 250 V to 1000 V.

11. A process cartridge that is detachable from an image forming apparatus, comprising:
an electrophotographic photoreceptor; and
a charging unit that charges a surface of the electrophotographic photoreceptor through a contact charging method in which only a direct voltage is applied,
and not having an erasing unit that erases the surface of the electrophotographic photoreceptor after the toner image formed on the surface of the electrophotographic photoreceptor is transferred to the recording medium using the transferring unit and before the surface of the electrographic photoreceptor is charged using the charging unit,
wherein the electrophotographic photoreceptor has a conductive substrate, an undercoat layer, and a photosensitive layer,
the undercoat layer has metallic oxide particles having been surface-treated with a coupling agent containing an amino group and an electron-accepting compound having an anthraquinone structure,
the electron-accepting compound is included in a range of 1 part by weight to 5 parts by weight with respect to 100 parts by weight of the metallic oxide particles, and
a volume resistivity of the undercoat layer is in a range of 1.0×10⁹ Ωm to 1.0×10¹⁰ Ωm in a measurement through an alternating current impedance method.

12. The process cartridge according to claim 11,
wherein the electron-accepting compound is a compound represented by the following formula (1): 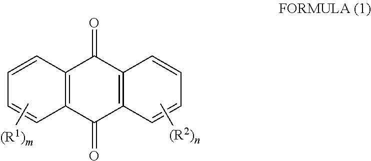
wherein in formula (1), R¹ and R² each independently represents a hydroxyl group, a methyl group, a methoxy methyl group, a phenyl group, or an amino group, and m and n each independently represents an integer of from 0 to 4.

13. The process cartridge according to claim 11,
wherein the electron-accepting compound is an electron-accepting compound having a hydroxyanthraquinone structure.

14. The process cartridge according to claim 11,
wherein a content of the electron-accepting compound is in a range of 2 parts by weight to 4 parts by weight with respect to 100 parts by weight of the metallic oxide particles included in the undercoat layer.

15. The process cartridge according to claim 11,
wherein a volume average particle diameter of the metallic oxide particles is in a range of 50 nm to 200 nm.

16. The process cartridge according to claim 11,
wherein a content of the metallic oxide particles is in a range of 2.5% by weight to 70% by weight with respect to the entire undercoat layer.
